(19) United States
(12) Patent Application Publication
(10) Pub. No.: US 2023/0237421 A1
(43) Pub. Date: Jul. 27, 2023

(54) DEVICE FOR INITIATION OF A PROCESS

(71) Applicant: YouGiver AG, Rotkreuz (CH)

(72) Inventor: Oleksandr KONOVALOV, Steinhausen (CH)

(73) Assignee: YouGiver AG, Rotkreuz (CH)

(21) Appl. No.: 18/007,929

(22) PCT Filed: Jun. 2, 2020
(86) PCT No.: PCT/EP2020/065191

§ 371 Date: Dec. 2, 2022

(51) Int. Cl. G06Q 10/083

(52) U.S. Cl. CPC G06Q 10/083

(57) ABSTRACT

A computing device for initiation of a process comprises a control unit which is configured to perform the steps of a corresponding method: Receive a request signal from a first remote computing device, the request signal referring to a second identifier attributed to a recipient. Retrieve a set of database entries depending on the second identifier. Transmit a response signal to the first remote computing device, the response signal including the set of database entries. Receive a selection signal from the first remote computing device, the selection signal including a selected database entry selected from the set of database entries and a first identifier attributed to a sender and requesting the initiation of the process. Retrieve location data attributed to the second identifier. Transmit an initiation signal to another remote computing device for initiation of the process, the initiation signal including the selected database entry and the location data. It is advantageous that the sender does not need to know the location data, and in particular that the location data is not transmitted to the first remote computing device.

### TECHNICAL FIELD

The present invention relates to a computing device for initiation of a process and to a corresponding computer-implemented method.

### BACKGROUND ART

If a first person wants to commission the delivery of a good or service, e.g. of a gift such as a bouquet of flowers, to a second person, she conventionally needs some kind of location data, e.g. the address, of the second person. This is still true for modern e-commerce platforms where the first person needs to fill in the delivery address of the second person.

In many situations, however, the first person does not know or is not supposed to know the address of the second person. A first example is the situation that the first person meets the second person, but the second person does not (yet) want to disclose her address, e.g. as a measure of precaution. A second example is the situation that a star or an influencer would like to offer to her fans or followers the possibility to make a gift without disclosing her address. Such situation is not resolved using current procedures and protocols of delivery or e-commerce.

### DISCLOSURE OF THE INVENTION

Hence, it is a general object of the invention to provide a computing device and a computer-implemented method through which a first person, i.e. the sender, can initiate a process, which e.g. comprises delivering a good or service to the second person, i.e. the recipient, without knowing the second person's address.

### General

Now, in order to implement this and further objects of the invention, which will become more readily apparent as the description proceeds, a computing device for initiation of the process comprises a control unit which is configured to perform the operations described below.

In general, the computing device may be implemented as at least one of a computer, a server, a virtual server, a distributed computer system or a cloud solution system. The operations may be performed as Software as a Service (SaaS) by a service provider, in particular without requiring an installation of any software on the device of the sender and/or on the device of the recipient. The computing device is configured to:
receive a request signal from a first remote computing device. The first remote computing device typically is a device used by the sender, e.g. the sender's computer or smartphone. The request signal refers to a second identifier attributed to the recipient. The second identifier may e.g. be a name, user name or identification number of the recipient which may be known to the sender.
retrieve a set of database entries depending on the second identifier. Advantageously, a database entry corresponds to at least one good or service, e.g. a gift. The dependency of the set on the second identifier may be embodied in different ways, e.g. as depending on location data attributed to the second identifier or as depending on a preselection of database entries through the recipient, as will be detailed further below.
transmit a response signal to the first remote computing device. The response signal includes the set of database entries. Typically, the database entries of the set will be displayed by the first remote computing device, e.g. with a picture or a description per database entry, in order to facilitate a selection through the sender.
receive a selection signal from the first remote computing device. The selection signal includes a selected database entry selected from the set of database entries. Further, the selection signal includes a first identifier attributed to the sender, and it requests the initiation of the process. In particular, the selection signal includes a confirmation that the process shall be performed with the selected database entry, e.g. that the selected gift shall be delivered to the recipient.
retrieve location data attributed to the second identifier. Typically, the location data corresponds to a physical address of the recipient. Further, the location data may comprise any data required for initiating the process, in particular at least one of a real name of the recipient, an e-mail address and a phone number of the recipient. In particular, the location data is unknown to the sender. Advantageously, the control unit is configured not to transmit the location data to the first remote computing device. Further advantageously, the control unit comprises blocking means for blocking the transmission of the location data to the first remote computing device. This has the advantage that the location data remains unknown to the sender, e.g. as a measure of precaution or protection of personal data.
transmit an initiation signal to another remote computing device for initiation of the process. In particular, the other remote computing device is a device, e.g. a computer, of a delivery operator carrying out the process. The initiation signal includes the selected database entry and the location data.

A second aspect of the present invention relates to a computer-implemented method for initiation of a process. The method comprises the operations described above as its method steps. A further aspect relates to a computer program product comprising instructions which, when the program is executed by a computer, cause the computer to carry out the method.

In the following, various advantageous embodiments of the invention are described. Features of the embodiments pertain to the device as well as to the method and are meant to be disclosed in all reasonable combinations.

### Static Link For The Sender

In a first advantageous embodiment, the control unit is further configured to
receive a first generation signal from the first remote computing device. The first generation signal includes the first identifier. Also, it requests generation of a first static link, e.g. a static web link, in particular a static link attributed to and usable by the sender.
generate the first static link.
attribute the first identifier to the first static link.
transmit the first static link to the first remote computing device.

As a result, the first static link is available to the sender. The sender may then use the first static link for the initiation of the process. In particular, if the sender wants to make a gift to the recipient, the sender may make the first static link available to the recipient, e.g. by forwarding the first static link to the recipient. In particular, in order to initiate the process, it is sufficient that the second remote computing device has available the first static link, while the recipient does not even need to know the name of the sender.

Since the link is a static link, it may be used by the sender multiple times, in particular to initiate multiple processes, e.g. with the same or different recipients. It is not necessary to re-generate a link for each initiation of a process. Thus the static link for the sender is a user-friendly implementation of initiating the process.

In an embodiment, the control unit is configured to
upon receiving the first static link from a second remote computing device, transmit a location query signal to the second remote computing device. Typically, the second remote computing device is a device, e.g. a computer or smartphone, used by the recipient. Then the recipient advantageously fills in the location data, e.g. her delivery address.
receive the location data from the second remote computing device.
attribute the location data to the second identifier. As a result, the delivery address is advantageously attributed to the recipient but remains unknown to the sender. The sender may then proceed with the initiation of the process by sending a request signal as described above in the section “General”.

Advantageously, the first static link may be used to initiate multiple processes with different location data. In particular, the sender may initiate multiple processes with the same recipient, while the recipient may provide different location data, e.g. different delivery addresses, in different processes. In an embodiment, the location data provided by the recipient is saved, e.g. in a database, such that it may be retrieved and does not need to be provided again when initiating multiple processes.

In an advantageous embodiment, the location query signal includes the first identifier. This means that the second remote computing device may display a name or user name of the sender to the recipient. The recipient is then in a position to either accept the initiation of the process, e.g. the delivery of a gift, by filling in the location data, or to refuse it.

Such freedom of the recipient to decide whether to accept or refuse the initiation of the process is also implemented in the following embodiment, wherein the control unit is configured to
upon receiving the first static link from the second remote computing device, first transmit a readiness query signal to the second remote computing device. The readiness query signal includes the first identifier, e.g. a name or user name of the sender, and asks for readiness for the initiation of the process.
only transmit the location query signal, if receiving a positive response to the readiness query signal. This means that the recipient needs to accept e.g. receiving a gift from the sender before a mask for filling in the location data is presented.

In a further embodiment, the control unit is configured to transmit a readiness signal to the first remote computing device when complete location data is attributed to the second identifier. In particular, the readiness signal may cause the first remote computing device to display to the sender that the receiver accepts to receive a gift from her. The sender may then proceed to send the request signal for initiating the process as described in the section “General” above.

### Static Link for the Recipient

In a second advantageous embodiment, the control unit is further configured to
receive a second generation signal from the second remote computing device, i.e. the device of the recipient, e.g. a computer or smartphone. The second generation signal includes the second identifier and requests generation of a second static link.
generate the second static link,
attribute the second identifier to the second static link, and
transmit the second static link to the second remote computing device.

As a result of these operations, the recipient has the static link available for the initiation of the process. The recipient may then make the second static link available to a potential sender from whom the recipient would e.g. like to receive a gift. This may typically be done by forwarding the second static link to the potential sender or by posting the second static link on a webpage or a blog.

Advantageously, the sender does not need to know any personal data of the recipient, e.g. not even her name. Rather it is sufficient for initiating the process that the first remote computing device has available the second static link.

In an advantageous embodiment, the second generation signal further includes the location data attributed to the second identifier. This means that e.g. the delivery address of the recipient is already linked to the second static link and does not need to be filled in at a later stage.

Advantageously, the second static link may be used to initiate multiple processes with different location data. In particular, the recipient may initiate multiple processes, while providing different location data, e.g. different delivery addresses, in different processes. This is particularly useful if the recipient travels or has several physical addresses that she visits over time. In this case, the delivery process is always based on the current physical address of the recipient such that she receives the gift, wherever she is currently located.

Both, the first static link attributed to the sender and the second static link attributed to the recipient, may be used several times by the sender or, respectively, the recipient in order to initiate the process of e.g. sending or, respectively, receiving a gift. Since there is no need to create new links for every process, the first and second static links are convenient to use.

In an advantageous embodiment, the first static link or the second static link are represented by a QR code. Such QR code may be printed e.g. on a calling card. Thus it is sufficient that a potential recipient scans the first static link or that a potential sender scans the second static link, e.g. with her smartphone, in order to prepare for initiating the process. This makes the first static link or, respectively, the second static link even more convenient to use.

### Further Advantageous Embodiments

In an advantageous embodiment, the selection signal further includes message data. In that case, the control unit is configured to include the message data in the initiation signal transmitted to the other remote computing device. In particular, the message data comprises a message from the sender to the recipient, which e.g. shall be transmitted to the recipient together with the gift.

In general, the process may comprise sending a message from the sender to the recipient, possibly even without sending a physical good. In general, the sender of the message does not need to know any contact details of the recipient, e.g. not even her name. In particular, it is sufficient that a communication is set up through the static link of the sender or the static link of the recipient as described above, which may be available from scanning a QR code from the sender's or, respectively, the recipient's calling card. Thus, this is a convenient way of sending a message while preserving privacy of both, the sender and the recipient.

In a further embodiment, the control unit is configured to
transmit a set formation signal to the second remote computing device. The set formation signal includes a second set of database entries. The second set may e.g. comprise all goods and services available for the process. Alternatively, the second set may comprise only goods and services which are located near to the address of the recipient as described further below. Advantageously, the second set only comprises database entries attributed to delivery operators who can complete the process, i.e. who can deliver the respective gift to the recipient's address.
receive a set selection signal from the second remote computing device. The set selection signal includes the set of database entries selected from the second set, wherein the set is a subset of the second set. In particular, the set of database entries corresponds to at least one database entry of the second set selected by the recipient.
attribute the set of database entries to the second identifier.

In this way, the recipient may define the set of database entries as a preselection e.g. of gifts that she would like to receive.

In an advantageous embodiment, each database entry has deliverer location data attributed to it. The deliverer location data may contain an address indicating where the good or service represented by the database entry is located before the delivery or an address indicating where the provider delivering the good or service is located. This facilitates the implementation of the following options:

The control unit may be configured to
assemble the set of database entries or the second set of database entries depending on the location data and the deliverer location data.
only include database entries in the set or in the second set which database entries' deliverer location data fulfill a proximity criterion in respect of the location data. Such proximity criterion may be formulated as a maximum distance between the location data and the deliverer location data, e.g. maximum 5, 10 or 20 km. Alternatively, the proximity criterion may require that the location data and the deliverer location data refer to the same country, the same region or the same city. In an embodiment, the location data and/or the deliverer location data comprise GPS data.

Advantageously, the deliverer location data comprises a territory indicated by the provider or seller where he is willing and able to complete the process, e.g. his service territory. In particular, the proximity criterion then checks whether the deliverer location data includes the location data, i.e. whether the recipient's address is located in the indicated territory. The implementation of the proximity criterion has the advantage that the process is carried out by local operators which saves money as well as the environment.

In an embodiment, the control unit is configured to direct the initiation signal for initiation of the process to another remote computing device based on a criterion minimizing time or cost. In particular, if a good or service represented by the selected database entry is available through different providers or delivery operators, an order for completing the process is given to the provider or delivery operator who indicates that he completes the process fastest or cheapest.

In a further advantageous embodiment, the control unit is configured not to transmit the first identifier to the other remote computing device, and in particular not to transmit the sender to the other remote computing device. Advantageously, the control unit comprises blocking means for blocking the transmission of the location data to the other remote computing device. This facilitates that the sender of a gift remains unknown to the delivery operator, again e.g. for reasons of protection of personal data.

In another embodiment, it may be required that the sender pays an amount of money, e.g. for the gift and for the delivery, before the process is initiated. In that case, the control unit is configured to transmit the initiation signal to the other computing device only when receiving a confirmation of payment of an amount depending on the selected database entry. A portion of the amount may be reserved for the service provider of the device or of the method. A processing of the payment may be outsourced to a payment service provider who sends the confirmation of payment only when the amount is transferred to the service provider of the device or of the method.

Optionally, the control unit is configured to only send a request for payment to the sender or to initiate a payment process after receiving a confirmation that the recipient accepts the initiation of the process.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a flow diagram of a process for initiating delivery of an article as known in the prior art;

FIG. 2 shows a schematic view of a protocol for initiating delivery of an article as known in the prior art;

FIG. 3 shows a flow diagram of a process for initiating delivery of an article according to an embodiment of the invention;

FIG. 4 shows a schematic view of a protocol for initiating delivery of an article according to an embodiment of the invention;

FIG. 5 shows a schematic view of a system and of the steps of a method for initiating delivery of an article according to an embodiment of the invention;

FIG. 6 shows a schematic view of a system and of the steps for generating a first static link for the sender in a method for initiating delivery of an article according to an embodiment of the invention;

FIG. 7 shows a schematic view of a system and of the steps for generating a second static link for the recipient in a method for initiating delivery of an article according to an embodiment of the invention.

### MODES FOR CARRYING OUT THE INVENTION

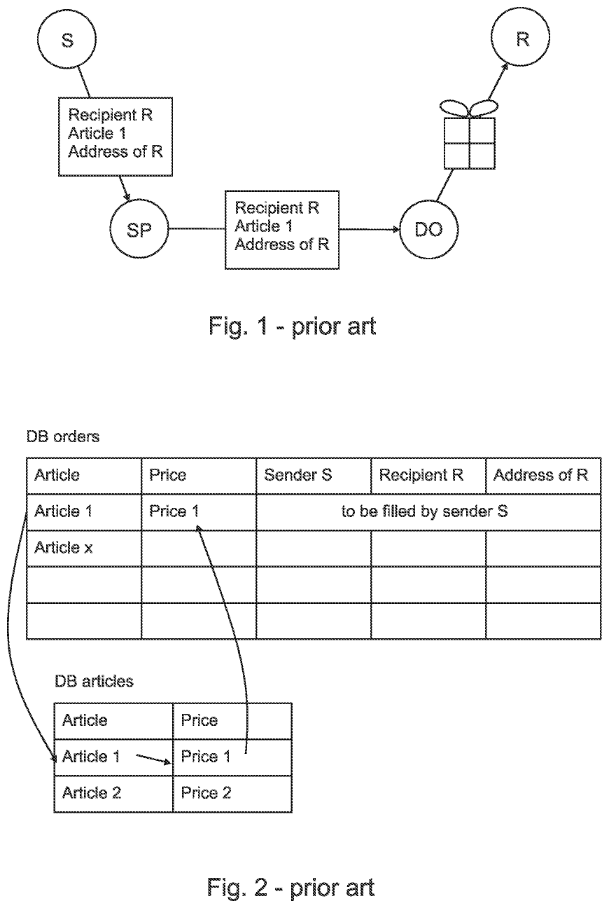

Conventionally, a sender needs to know the address, i.e. location data, of the recipient if she wants to send an article, e.g. a good or service or a gift, to the recipient. This situation is depicted in FIGS. 1 and 2: The sender S chooses an article 1 from a catalogue which is represented by a database of articles (DB articles) provided by a service provider SP, e.g. an e-commerce platform or marketplace. The DB articles typically contains a price for each article.

The service provider SP uses a database of orders, DB orders e.g. as shown in FIG. 2, to manage all incoming orders. The price is typically filled into DB orders automatically by retrieving it from DB articles. The name and address of the recipient R need to be provided to the service provider SP by the sender S.

The service provider SP initiates the process of delivery e.g. of the article by transmitting the name is and address of the recipient R as well as the selected article 1 to a delivery operator DO. The delivery operator DO then carries out the process of delivery and delivers the article to the address of the recipient R.

The circumstance that the sender S needs to know the address of the recipient R is a significant obstacle in many situations as described in the Background Art section above. This obstacle is overcome by embodiments of the present invention.

For other existing delivery services in the state of the art, the sender needs to know the phone number of the recipient which he passes on to the delivery operator. The delivery operator will then contact the recipient and ask for her address. This is neither practical nor safe for various reasons: Firstly, the sender may get to know the recipient's address from the delivery operator. Secondly, a final price for the process cannot be fixed in advance since the recipient's address is a priori unknown to the delivery operator. Thirdly, calling the recipient for retrieving her address is quite tedious and time-consuming. These obstacles are overcome by embodiments of the present invention.

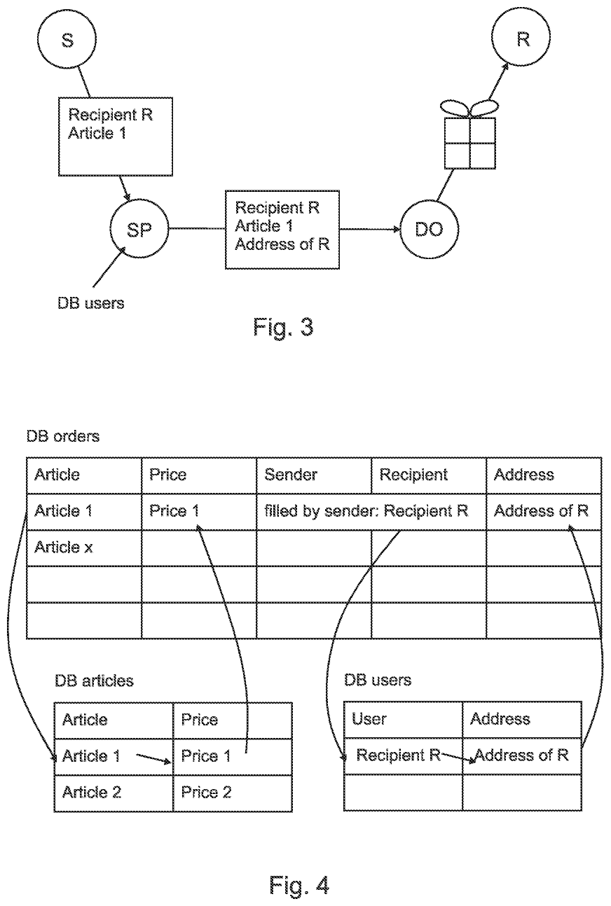

FIGS. 3 and 4 show a process and a schematic protocol, respectively, of how to initiate the process of delivery according to an embodiment of the invention: The sender S provides the name of the recipient R and the article 1 that she wants to send to the service provider SP. But the sender does not provide the address of the recipient R.

The service provider SP again uses a DB orders to manage the incoming orders as in the situation above. However, the service provider SP additionally maintains a database of users, DB users, wherein the address of a user is attributed to the name of the user. The service provider SP then uses DB users to fill in the address of the recipient R in DB orders before initiating the delivery process with the delivery operator DO by transmitting the data regarding name and address of the recipient R as well as the selected article 1. Finally, the delivery operator DO carries out the delivery process, and recipient R receives the selected article 1.

In general, there may also be a confirmation of delivery which the delivery operator DO transmits to the service provider SP after having delivered article 1 to recipient R. The service provider SP may further transmit such confirmation of delivery to the sender S e.g. in order to reassure her that the delivery has been effected.

In general, a payment service (not shown) may be involved in the process of initiating the delivery. In particular, the service provider SP only transmits the data shown in FIG. 3 to the delivery operator DO, thereby ordering the delivery of the article, when it has received an amount of money depending on the article via the payment service. Alternatively, the service provider SP may receive a confirmation of payment from the payment service when the payment of the amount of money is received on behalf of the service provider SP.

The method and protocol for initiating the process according to embodiments of the invention has the advantage that the sender does not need to know the address of the receiver. Further, the sender does not get to know the address of the receiver in the course of the process. Thus, embodiments of the invention solve the problem of keeping personal data of the recipient, such as the address, confidential. In a sense, the invention hence relates to a novel protocol for performing e-commerce. This enables use cases that simply were not feasible before, such as a person receiving a gift from another person while keeping her address or even her real name secret, e.g. in the relationship influencer-follower or in a love affair in its beginning stage.

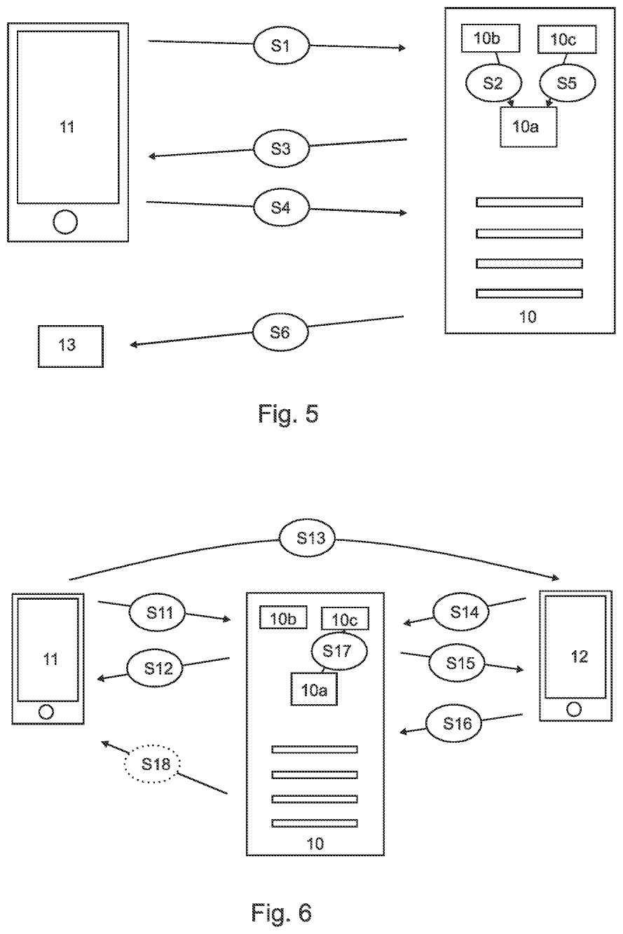

FIG. 5 shows a schematic view of a system and of the steps of a method for initiating delivery of an article according to an embodiment of the invention. The system comprises a device 10 which in particular is a server or virtual server of the service provider SP. The device 10 comprises a control unit 10a connected to memory for different databases, e.g. 10b and 10c. The device 10 is configured to communicate with a first remote computing device, e.g. the smartphone 11 of the sender S, and with another remote computing device, e.g. a computer 13 of the delivery operator DO.

FIG. 5 depicts a process similar to the one of FIGS. 3 and 4 in a different way, namely as steps of a method for initiating the process of delivery from the point of view of the device 10. When the sender S wants to send an article e.g. to make a gift, she uses her smartphone 11 to send a request to the service provider SP. In step S1, the control unit 10a receives the request comprising a second identifier attributed to the intended recipient R, e.g. the name of the recipient R. In step S2, the control unit retrieves the catalogue of articles e.g. as a set of database entries from the DB articles 10b. The set of database entries is transmitted to the sender's smartphone 11 in step S3.

In an advantageous embodiment, the set of database entries retrieved in step S2 only contains entries, i.e. articles, which are located near to the recipient's address, e.g. in the same country or city. In order to filter the entries of the DB articles according to such proximity criterion and form the set of database entries, the control unit first retrieves the address attributed to the recipient R from the DB users. Further, the DB articles comprises a delivery address attributed to each article which may in particular be the location of the delivery operator DO or the location where the respective article is currently stored. The proximity criterion is evaluated on the basis of the recipient's address and the article's delivery address. Only articles, i.e. database entries, which fulfill the proximity criterion are included in the set. The implementation of such filtering or proximity criterion helps to save costs and the environment.

Typically, the articles corresponding to the set of database entries are then shown to the sender S on her smartphone 11. The sender S selects one or more articles which triggers that the control unit receives the selection of the one or more database entries in step S4. At the same time, receiving the selection may be taken as the trigger for initiating the process of delivery. Alternatively, a payment of an amount of money depending on the one or more database entries may be required as described above before the process is initiated.

In step S6, the control unit 10 transmits an order to the other remote computing device 13. The order is represented by an initiation signal comprising the name and address of the recipient R as well as the one or more articles, i.e. selected database entries.

An important question remains: How does the device 10 know the address of the recipient R if it is not provided by the sender S? In the following, three solutions are presented for this problem.

In a first embodiment, a first static link is generated for the sender. Such static link may be useful when two persons have met, and one wants to send a gift to the other without knowing the other's address. The corresponding method steps are shown in FIG. 6. The sender wanting to send an article to an intended recipient sends a request to generate a static link to the device 10, e.g. by visiting a website of the service provider or by selecting the corresponding option in an app of the service provider. In step S11, the control unit 10a receives the request from the sender's smartphone 11 (or any other remote computing device). The request comprises information about the sender, i.e. a first identifier attributed to the sender, e.g. the sender's name.

The control unit 10a generates the static link, attributes the first identifier to the static link, e.g. in an extended DB users, and transmits the static link back to the sender's smartphone 11 in step S12. As a result, the sender now has the static link available to initiate a process of delivery of an article multiple time, if desired, without having to re-register. Thus, such static link is easy, time-saving and convenient to use.

In step S13, which takes place without interaction with the device 10, the sender makes the static link available to the recipient, e.g. by forwarding it via e-mail or any messenger. Through the recipient clicking on or opening the static link on her remote computing device, e.g. a computer or smartphone 12, the control unit 10a is addressed in step S14. As a result, the control unit 10a transmits an address query to the recipient's device 12 in step S15. Advantageously, the address query is displayed on the recipient's device 12 in form of a mask where the recipient is asked to fill in her address, i.e. location data. Further advantageously, the address query comprises the first identifier, e.g. the name of the sender attributed to the static link, and the first identifier is displayed to the recipient. This enables the recipient to decide if she wants to receive a gift, i.e. an article, from this sender.

When the recipient has filled in the address, the control unit 10a receives it from the recipient's device 12 in step S16. Alternatively, if the recipient has registered her address with the control unit 10a such that it is e.g. available in the DB users, the recipient only needs to confirm the address, or—in case of several registered addresses—choose an appropriate address for the present delivery. In step S17, the control unit 10a attributes the address to the first identifier representing the recipient, in particular by storing it in the database DB users 10c. Now, the sender may initiate the process of delivery by continuing with step S1 as illustrated in FIG. 5.

Advantageously, the control unit 10a transmits a confirmation of the address registration to the sender's device 11 in step S18. Such confirmation may comprise a link referring to the second identifier representing the recipient such that the sender may directly proceed to request the initiation of the process as depicted in FIG. 5 by clicking on or opening the link.

The static link attributed to the first identifier, i.e. to the sender, poses the following challenge: It is still not desired that the sender gets to know the address of the receiver. At the same time, the static link is to be re-used multiple times, meaning that different people click on it, which may even include the sender herself clicking on the static link without getting to know the recipient's address or other personal data.

In an advantageous embodiment, this challenge is resolved by introducing steps S14a and S14b (not shown) between steps S14 and S15 of FIG. 6. When the control unit 10a is addressed from the device 12 in step S14, it first transmits an identity query to the device 12 in step S14a before transmitting the address query in step S15. As a response to the identity query, the recipient needs to identify herself either as the intended recipient who wants to accept receiving a gift, i.e. an article; or, if the user of device 12 is not the intended recipient or even is the sender, then she may identify herself as not-the-intended-recipient. Hence, in step S14b, the control unit 10a receives a positive or negative response to the identity query, and only proceeds with step S15 if the response is positive, i.e. the identity is the intended recipient.

Advantageously, in step S14b, the control unit 10a also receives a device identifier of device 12, e.g. the MAC address of device 12. In that case, the control unit 10a may be configured to only proceed with step S15 once for each distinct device identifier. In this way, a re-registration of a recipient may be avoided whereas the static link is still usable multiple times. At the same time, this facilitates blocking the sender from getting to know the address of the recipient.

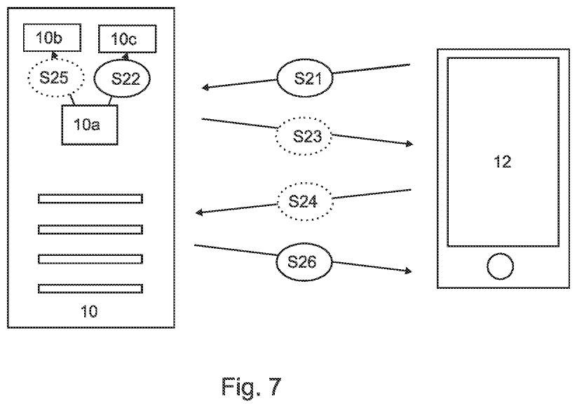

In a second embodiment, a second static link is generated for the recipient. Such second static link may be useful for a star or influencer who would like to receive gifts or donations from fans or followers without making her address known. The corresponding method steps are shown in FIG. 7. The recipient, e.g. the star or influencer, addresses the control unit 10a with a request to generate such static link. The request comprises the second identifier representing the recipient, e.g. her name, and her address. In step S21, the control unit 10a receives the request from the device 12, which may e.g. be a smartphone or computer of the recipient.

In step S22, the control unit 10a generates the static link and attributes it to the second identifier. In particular, the device attributes the address to the second identifier, e.g. by storing both in the database DB users 10c.

In step S26, the static link is transmitted to the device 12. As a result, the recipient has the static link available in order to initiate a process of delivery, if desired multiple times. The recipient may then forward the static link to a potential sender, either by personal forwarding via e-mail or any messenger or by posting the static link on a website or a blog. The is sender may then continue with initiating the process, e.g. by step S1 as shown in FIG. 5.

In an embodiment, the recipient may define more closely the articles she would like to receive, e.g. by filtering the catalogue of articles as represented by the database DB articles. This is illustrated as optional steps S23 to S25 in FIG. 7. After receiving the request to generate the static link in step S21 and in particular after step S22, the control unit 10a transmits the whole catalogue of articles, i.e. a second set of database entries of DB articles, to the device 12. The second set may actually represent the entire set of database entries in DB articles, or it may result from a filtering according to the proximity criterion as described above. The recipient then selects one or more database entries that she would like to receive, thereby forming the set of database entries, which is a subset of the second set. The forming of the set may e.g. be implemented as a manual selection or as a filtering operation, e.g. according to categories of articles. In step S24, the control unit 10a receives the set of database entries from the device 12. In step S25, the control unit 10a attributes the set to the second identifier before it continues with step S26.

In a third embodiment, the control unit communicates with a pre-existing database of address data and uses it as the DB users. Such database may e.g. be a database of a social media service or of a messenger which has address data available. If the second identifier, e.g. the recipient's name, is attributed to an address in such database, the control unit retrieves this address, and there is no need for the recipient to repeatedly fill in her address.

In general, the method described above may be run in a Software as a Service (SaaS) manner hosted by the service provider SP. In an advantageous embodiment, an application programming interface (API) is provided to n developers of the social media service or of the messenger in order to make the pre-existing database available. Advantageously, the described method is implemented into the social media service or the messenger via the API such that it can be performed from within the social media service or the messenger, i.e. without visiting another website or using another app.

While there are shown and described presently preferred embodiments of the invention, it is to be distinctly understood that the invention is not limited thereto but may be otherwise variously embodied and practiced within the scope of the following claims.

1. Computing device for initiation of a process, comprising a control unit configured to
receive a request signal from a first remote computing device, the request signal
referring to a second identifier attributed to a recipient,
retrieve a set of database entries depending on the second identifier,
transmit a response signal to the first remote computing device, the response signal
including the set of database entries,
receive a selection signal from the first remote computing device, the selection signal
including a selected database entry selected from the set of database entries and
including a first identifier attributed to a sender,
requesting the initiation of the process,
retrieve location data attributed to the second identifier,
transmit an initiation signal to another remote computing device for initiation of the process, the initiation signal
including the selected database entry and
including the location data.

2. Device according to claim 1,
wherein the control unit is configured not to transmit the location data to the first remote computing device by comprising blocking means for blocking the transmission of the location data to the first remote computing device.

3. Device according to claim 1,
the selection signal further
including message data,
wherein the control unit is configured to
include the message data in the initiation signal transmitted to the other remote computing device,
wherein the message data comprises a message from the sender to the recipient.

4. Device according to claim 1,
wherein the control unit is configured to
receive a first generation signal from the first remote computing device, the first generation signal
including the first identifier,
requesting generation of a first static link,
generate the first static link,
attribute the first identifier to the first static link,
transmit the first static link to the first remote computing device.

5. Device according to claim 4,
wherein the control unit is configured to
upon receiving the first static link from a second remote computing device, transmit a location query signal to the second remote computing device,
receive the location data from the second remote computing device,
attribute the location data to the second identifier,
the location query signal
including the first identifier.

6. Device according to claim 5,
wherein the control unit is configured to
upon receiving the first static link from the second remote computing device, first transmit a readiness query signal to the second remote computing device, the readiness query signal
including the first identifier,
asking for readiness for the initiation of the process,
only transmit the location query signal, if receiving a positive response to the readiness query signal.

7. Device according to claim 5,
wherein the control unit is configured to
transmit a readiness signal to the first remote computing device when complete location data is attributed to the second identifier.

8. Device according to claim 1, wherein the control unit is configured to
receive a second generation signal from a second remote computing device, the second generation signal
including the second identifier,
requesting generation of a second static link,
generate the second static link,
attribute the second identifier to the second static link, transmit the second static link to the second remote computing device.

9. Device according to claim 8,
the second generation signal further
including the location data attributed to the second identifier.

10. Device according to claim 8,
wherein the control unit is configured to
transmit a set formation signal to the second remote computing device, the set formation signal
including a second set of database entries,
receive a set selection signal from the second remote computing device, the set selection signal
including the set of database entries selected from the second set, wherein the set is a subset of the second set,
attribute the set of database entries to the second identifier,
wherein the set of database entries corresponds to at least one database entry of the second set selected by the recipient.

11. Device according to claim 1,
wherein each database entry has deliverer location data attributed to it.

12. Device according to claim 11,
wherein the control unit is configured to
assemble the set of database entries depending on the location data and the deliverer location data.

13. Device according to claim 11,
wherein the control unit is configured to
assemble the second set of database entries depending on the location data and the deliverer location data.

14. Device according to claim 12,
wherein the control unit is configured to
only include database entries in the set or in the second set which database entries' deliverer location data fulfill a proximity criterion in respect of the location data,
wherein at least one of the location data and the deliverer location data comprises GPS data.

15. Device according to claim 1,
wherein the control unit is configured
not to transmit the first identifier to the other remote computing device,
not to transmit the sender to the other remote computing device, by comprising blocking means for blocking the transmission of the location data to the other remote computing device

16. Device according to claim 1,
wherein the first static link or the second static link are represented by a QR code.

17. Device according to claim 1,
wherein the location data corresponds to a physical address of the recipient,
wherein the location data is unknown to the sender.

18. Device according to claim 1,
wherein the process comprises delivering a good or service,
wherein a database entry corresponds to at least one good or service.

19. Device according to claim 1,
wherein the control unit is configured to
transmit the initiation signal to the other computing device only when receiving a confirmation of payment of an amount depending on the selected database entry.

20. Computer-implemented method for initiation of a process, the method comprising the following steps:
receive a request signal from a first remote computing device, the request signal
referring to a second identifier attributed to a recipient,
retrieve a set of database entries depending on the second identifier,
transmit a response signal to the first remote computing device, the response signal
including the set of database entries,
receive a selection signal from the first remote computing device, the selection signal
including a selected database entry selected from the set of database entries and
including a first identifier attributed to a sender,
requesting the initiation of the process,
retrieve location data attributed to the second identifier,
transmit an initiation signal to another remote computing device for initiation of the process, the initiation signal
including the selected database entry and
including the location data.

21. Computer program product comprising instructions which, when the program is executed by a computer, cause the computer to carry out the method of claim 20.
